(19) United States
(12) Patent Application Publication
(10) Pub. No.: US 2016/0036263 A1
(43) Pub. Date: Feb. 4, 2016

(54) ON-VEHICLE WIRELESS CHARGING SYSTEM, WIRELESS CHARGER AND CAR CHARGER THEREOF

(71) Applicant: HON HAI PRECISION INDUSTRY CO., LTD., New Taipei (TW)

(72) Inventor: KUANG-YAO LIAO, New Taipei (TW)

(21) Appl. No.: 14/753,281

(22) Filed: Jun. 29, 2015

(30) Foreign Application Priority Data
Jul. 29, 2014 (TW) 103125894

(51) Int. Cl. H02J 7/02; H02J 7/14

(52) U.S. Cl. CPC H02J 7/025; H02J 7/14

(57) ABSTRACT

A wireless charger includes a charging base and a charging contact point protruding from the charging base. The charging base includes a wireless charging module, a GPS transmitting antenna positioned adjacent to the wireless charging module, and a GPS contact point coupled to the GPS transmitting antenna and protruding from the charging base. The charging contact point is coupled to the wireless charging module. A car charger adapted to the wireless charger and an on-vehicle charging system including the wireless charger and the car charger are also disclosed.

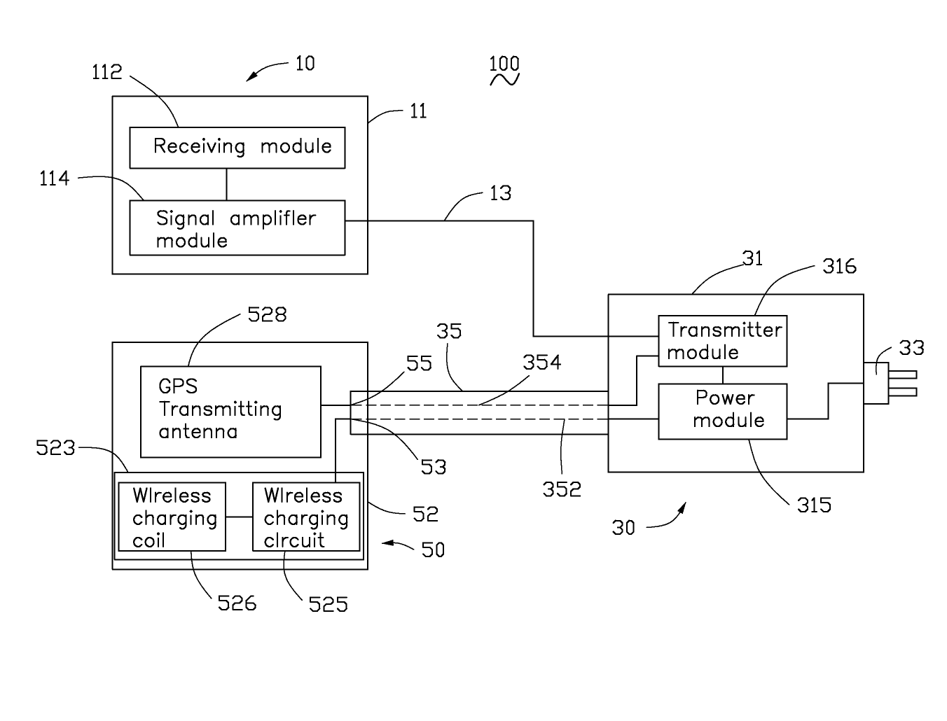

### FIELD

The subject matter herein generally relates to an on-vehicle wireless charging system, a wireless charger and a car charger thereof.

### BACKGROUND

Intelligent devices, such as mobile phones, have been widely used in automotive electronics market to provide navigation, web search, hands-free calls and related services.

However, when a global position system (GPS) device used in a vehicle is influenced by a sheathing paper or placed improperly, GPS signal strength is weak, and the navigation function of the mobile phone would not be use. Furthermore, the mobile phones would consume a large amount of power when using the navigation function, and more and more mobile phones have the wireless charging function.

### BRIEF DESCRIPTION OF THE DRAWING

Implementations of the present technology will now be described, by way of example only, with reference to the attached drawing.

The figure is block diagram of one embodiment of an on-vehicle wireless charging system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is relation to an on-vehicle wireless charging system, a wireless charger and a car charger thereof.

The figure illustrates that an on-vehicle wireless charging system 100 can include a signal receiver 10, a car charger 30, and a wireless charger 50. The signal receiver 10 can be mounted at an automotive chassis outside a vehicle and electrically coupled to the car charger 30. The signal receiver 10 can be configured to receive external GPS signal and transmit the GPS signal to the car charger 30 positioned in the vehicle. The car charger 30 can be electrically coupled to the signal receiver 10 and the wireless charger 50, and configured to supply power to the wireless charger 50 and transmit the GPS signal to the wireless charger 50. The wireless charger 50 can be configured to receive the GPS signal transmitted by the car charger 30, and transmit the GPS signal and supply power to an electronic device positioned thereon.

The signal receiver 10 can include a receiving base 11 and a transmission line 13 coupled to the receiving base 11. The receiving base 11 can be positioned at the automotive chassis outside the vehicle, and include a receiving module 112 and signal amplifier module 114 therein. The signal receiving module 112 can be configured to receive the external GPS signal. The signal amplifier module 114 can be electrically coupled to the receiving module 112 and configured to amplify the GPS signal transmitted from the receiving module 112. The transmission line 13 can be connected to the signal amplifier module 114 and electrically coupled to the car charger 30. The GPS signal received by the signal receiving module 112 and amplified by the signal amplifier module 114 can be transmitted to the car charger 30 through the transmission line 13.

The car charger 30 can be electrically coupled to an external power source (not shown) and the signal receiver 10. The car charger 30 can include a main body 31, a plug 33, and a vehicular cable 35. The main body 31 can include a power module 315 and a transmitter module 316 therein. The power module 315 can be electrically coupled to the transmitter module 316 and configured to supply power to the transmitter module 316. The transmitter module 316 can be electrically coupled to the transmission line 13, thus the GPS signal received by the receiving module 112 can be transmitted to the transmitter module 316. The plug 33 can be mounted on the main body 31 and partially protrude out of the main body 31. The plug 33 can be coupled to the power module 315 and adapted to an external power plug (not shown) to transmit the external electrical power to the power module 315.

Two ends of the vehicular cable 35 can be electrically coupled to the main body 31 and the wireless charger 50. The vehicular cable 35 can include an electrical lead 352 and a GPS lead 354 therein. One end of the electrical lead 352 can be connected to the power module 315 of the main body 31, and the other end of the electrical lead 352 can include a charging pin (not shown). The charging pin can be electrically coupled to the wireless charger 50, thus the electrical power of the power module 315 can be transmitted to the wireless charger 50. One end of the GPS lead 354 can be connected to the transmitter module 316 of the main body 31, and the other end of the GPS lead 354 can include a GPS pin (not shown). The GPS pin can be electrically coupled to the wireless charger 50, thus the GPS signal of the transmitter module 316 can be transmitted to the wireless charger 50.

The wireless charger 50 can include a charging base 52, a charging contact point 53 and a GPS contact point 55 protruding from the charging base 52. The charging contact point 53 can be adapted to charging pin, and the GPS contact point 55 can be adapted to the GPS pin of the vehicular cable 35. The charging base 52 can include a wireless charging module 523 and a GPS transmitting antenna 528. The wireless charging module 523 can be electrically coupled to the charging contact point 53, and electrically coupled to the electrical lead 352 via the charging contact point 53. The wireless charging module 523 can be electrically coupled to the power module 315 via the electrical lead 352, thus the power module 315 can supply power to the wireless charging module 523. In at least one embodiment, the wireless charging module 523 can include a wireless charging circuit 525 and a wireless charging coil 526. The wireless charging circuit 525 can be electrically coupled to the electrical lead 352 of the vehicular cable 35, and the wireless charging coil 526 can be electrically coupled to the wireless charging wireless charging circuit 525, thus the electronic device positioned on the wireless charging coil 526 can be charged. The GPS transmitting antenna 528 can be electrically coupled to the GPS contact point 55, and further coupled to the GPS lead 354 via the GPS contact point 55. The GPS transmitting antenna 528 can be coupled to the transmitter module 316 of the car charger 30 via the GPS lead 354, and configured to transmit the GPS signal from the transmitter module 316 to an electronic device having GPS function. The electronic device can be a mobile phone. In at least one embodiment, the GPS transmitting antenna 528 can be positioned adjacent to the wireless charging coil 526, thereby the electronic device positioned on the wireless charging coil 526 can get a better GPS signal strength.

In assembling, the receiving base 11 of the signal receiver 10 can be positioned at the automotive chassis outside the vehicle, and the transmission line 13 can be connected between the signal receiver 10 and the car charger 30. Then, the plug 33 of the car charger 30 can be inserted into a power socket in the vehicle, and the vehicular cable 35 can be connected between the car charger 30 and the wireless charger 50.

In use, the plug 33 can acquire electrical power from the power socket, and transmit the electrical power to the power module 315. The electrical lead 352 of the vehicular cable 35 can transmit the electrical power to the wireless charging module 523, and the wireless charging module 523 can charge the electronic device positioned thereon. The signal receiver 10 can receive the external GPS signal, and the signal amplifier module 114 can amplify and transmit the GPS signal to the transmitter module 316 of the car charger 30 via the transmission line 13. The transmitter module 316 can transmit the GPS signal to the GPS transmitting antenna 528 in the wireless charger 50 via the GPS lead 354 in the vehicular cable 35. The GPS transmitting antenna 528 can transmit the GPS signal to the electronic device positioned on or adjacent to the wireless charger 50.

The wireless charger 50 of this disclosure can include the GPS transmitting antenna 528 therein, and the vehicular cable 35 can include the GPS lead 354 therein. In use, the signal receiver 10 positioned outside the vehicle and the car charger 30 including the transmitter module 316 can transmit the GPS signal into the vehicle. The vehicular cable 35 including the GPS lead 354 can transmit the GPS signal from the car charger 30 to the GPS transmitting antenna 528 of the wireless charger 50. As the electronic device can be positioned adjacent to the wireless charger 50, the GPS signal strength received by the electronic device can be improved. Moreover, the GPS lead 354 can be arranged in the vehicular cable 35, the cost of wire can be saved, and it is convenient to use.

In other embodiments, the signal amplifier module 114 can be omitted, and the receiving module 112 can be directly coupled to the transmission line 13.

The embodiments shown and described above are only examples. Many details are often found in the art such as the other features of a wireless charger, a car charger, and an on-vehicle wireless charging system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, comprising in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A wireless charger comprising:
a charging base comprising
a wireless charging module;
a GPS transmitting antenna positioned adjacent to the wireless charging module, and
a GPS contact point coupled to the GPS transmitting antenna and protruding from the charging base; and
a charging contact point protruding from the charging base and coupled to the wireless charging module.

2. The wireless charger as claimed in claim 1, wherein the wireless charging module comprises a wireless charging circuit and a wireless charging coil electrically coupled to the wireless charging circuit, and the GPS transmitting antenna is positioned adjacent to the wireless charging coil.

3. A car charger comprising:
a main body comprising a power module and a transmitter module coupled to the power module;
a plug mounted on the main body; and
a vehicular cable comprising an electrical lead and a GPS lead therein;
wherein one end of the electrical lead is coupled to the power module, and one end of the GPS lead is coupled to the transmitter module.

4. An on-vehicle wireless charging system comprising:
a signal receiver configured to receive external GPS signal;
a car charger comprising:
a main body comprising a power module and a transmitter module electrically coupled to the power module, the transmitter module coupled to the signal receiver;
a plug mounted on the main body; and
a vehicular cable comprising an electrical lead and a GPS lead; and
a wireless charger comprising a charging base, the charging base comprising:
a wireless charging module; and
a GPS transmitting antenna positioned adjacent to the wireless charging module;
wherein the GPS lead is electrically coupled to the transmitter module of the car charger and the GPS transmitting antenna of the charging base to transmit the GPS signal from the car charger to the charging base.

5. The on-vehicle wireless charging system as claimed in claim 4,
wherein the signal receiver comprises a receiving base positioned at automotive chassis outside a vehicle and a transmission line coupled to the receiving base; and
wherein the receiving base comprises a receiving module configured to receive the external GPS signal, and the transmission line is coupled to the receiving module and the transmitter module of the car charger.

6. The on-vehicle wireless charging system as claimed in claim 4,
wherein the signal receiver comprises a receiving base positioned at automotive chassis outside a vehicle and a transmission line coupled to the receiving base;
wherein the receiving base comprises a receiving module and a signal amplifier module; and
wherein the receiving module is configured to receive the external GPS signal and transmit the GPS signal to the signal amplifier module, and the signal amplifier module is configured to amplify the GPS signal and transmit the GPS signal to the transmitter module.

7. The on-vehicle wireless charging system as claimed in claim 4, wherein the wireless charging module comprises a wireless charging circuit and a wireless charging coil, the wireless charging circuit is electrically coupled to the electrical lead of the vehicular cable, and the wireless charging coil is electrically coupled to the wireless charging circuit.
